(19) United States
(12) Patent Application Publication
(10) Pub. No.: US 2018/0119627 A1
(43) Pub. Date: May 3, 2018

(54) WIRELESS TURBO BOOST CONTROLLER

(71) Applicant: ISR Performance Parts, LLC, Clermont, FL (US)

(72) Inventors: Ken Harrison, Clermont, FL (US); Theodore Hintz, Plano, TX (US); Jason Liebert, Plano, TX (US); Clyde James Smittle, Plano, TX (US)

(21) Appl. No.: 15/343,031

(22) Filed: Nov. 3, 2016

(51) Int. Cl. F02D 41/00; F02D 41/26; F02B 37/18; H04W 4/00

(52) U.S. Cl. CPC F02D 41/0007; F02D 41/26; F02D 2200/101; H04W 4/008; F02D 2200/0406; F02B 37/186

(57) ABSTRACT

A wireless turbo boost controller, a computer program product for operating a wireless turbo boost controller in a turbo system of a vehicle, and a turbo boost control system for a vehicle are provided herein. In one embodiment, the wireless turbo boost controller includes: (1) a wireless communication module, (2) an input interface configured to receive a pressure signal indicative of a manifold pressure of an engine of the vehicle and a RPM signal indicative of an RPM of the engine of the vehicle, and (3) a processor configured to control the wastegate solenoid of the turbo system based on the pressure signal, the RPM signal, and at least one program setting received via the wireless communication module.

### TECHNICAL FIELD

This application is directed, in general, to turbochargers in vehicles and, more specifically, to turbo boost controllers.

### BACKGROUND

Whether passing another vehicle, going up an incline, or just wanting to go faster, drivers often desire more power from their vehicles. A turbocharger is one device that is used to increase the power output of an internal combustion engine. A turbocharger is powered by a turbine driven by an engine's exhaust gas and increases the power output of the engine by forcing additional air into the combustion chamber. A wastegate actuator (i.e., a wastegate) is used to relieve pressure in a turbocharger by opening when a turbo boost pressure is reached. A control spring inside of the wastegate will open at a controlled PSI so that the turbo boost pressure never exceeds a defined value referred to as the wastegate spring pressure. Alternatively, an external wastegate pressure on the bottom port of the wastegate helps keep the wastegate closed and pressure on the top port of the wastegate helps open the wastegate so that the turbo boost pressure never exceeds the wastegate spring pressure.

### SUMMARY

In one aspect, the application provides a wireless turbo boost controller configured to control a wastegate solenoid of a turbo boost control system of a vehicle. In one embodiment, the wireless turbo boost controller includes: (1) a wireless communication module, (2) an input interface configured to receive a pressure signal indicative of a manifold pressure of an engine of the vehicle and a RPM signal indicative of an RPM of the engine of the vehicle, and (3) a processor configured to control the wastegate solenoid of the turbo system based on the pressure signal, the RPM signal, and at least one program setting received via the wireless communication module.

In another aspect, the disclosure provides a computer program product for operating a wireless turbo boost controller in a turbo system of a vehicle, wherein the computer program product includes code stored on a non-transitory computer-readable medium of a mobile computing device that directs a processor of the mobile computing device to perform a method to direct operation of a wireless turbo boost controller. In one embodiment, the method includes: (1) providing a setpoint duty cycle and (2) sending the setpoint duty cycle to the wireless turbo boost controller via a wireless communication module, wherein the wireless turbo boost controller generates a solenoid control signal from a pressure signal indicative of a manifold pressure of an engine of the vehicle, a RPM signal indicative of an RPM of the engine of the vehicle, and the setpoint duty cycle.

In yet another aspect, the disclosure provides a turbo boost control system for a vehicle. In one embodiment, the turbo boost control system includes: (1) a wastegate solenoid; and (2) a wireless turbo boost controller configured to control the wastegate solenoid, the wireless turbo boost controller having (2A) a wireless communication module, (2B) an input interface configured to receive a pressure signal indicative of a manifold pressure of an engine of the vehicle and a RPM signal indicative of an RPM of the engine of the vehicle, and (2C) a processor configured to control the wastegate solenoid based on the pressure signal, the RPM signal, and at least one program setting received via the wireless communication module.

### BRIEF DESCRIPTION OF THE DRAWINGS

Reference is now made to the following descriptions taken in conjunction with the accompanying drawings, in which:

FIG. 1 illustrates a block diagram of an embodiment of a turbo boost control system constructed according to the principles of the disclosure;

FIG. 2 illustrates an embodiment of a display of a mobile computing device having a turbo control application as disclosed herein;

FIG. 3 illustrates a flow diagram of an embodiment of a method of remotely operating a wireless turbo boost controller carried out according to the principles of the disclosure;

FIG. 4A, FIG. 4B, FIG. 4C, and FIG. 4D illustrate embodiments of data structures that are used to communicate data between a mobile computing device and a wireless communication module as disclosed herein; and

FIG. 5 illustrates a flow diagram of another embodiment of a method of remotely operating a wireless turbo boost controller carried out according to the principles of the disclosure.

### DETAILED DESCRIPTION

Turbo boost controllers “trick” the wastegate by using a wastegate solenoid valve (i.e., a solenoid) to regulate the manifold pressure applied to the wastegate. The solenoid is used to allow the turbo boost pressure to increase to a defined level that may exceed the wastegate spring pressure. The solenoid accomplishes this by preventing the turbo boost pressure from being exposed to the wastegate until triggered by the turbo boost controller. This occurs because when the solenoid is closed, the turbo boost pressure is not applied to the wastegate spring, therefore it will not be vented to atmosphere and pressure is allowed to build. For example, to control the amount of pressure applied to the wastegate, the solenoid is pulsed with a PWM waveform at a specific frequency and duty cycle. If the duty cycle is increased, then less pressure is applied to the wastegate, so the manifold pressure is not applied to the wastegate spring and pressure is allowed to build up in the turbocharger. If the duty cycle is decreased, more pressure is applied to the wastegate which will ultimately cause the wastegate to open as the duty cycle approaches 0% and the solenoid is fully open. In this way, the duty cycle applied to the solenoid controls the amount of pressure applied to the wastegate.

It is realized herein that each driver may desire different program settings for the turbochargers of their particular vehicle. It is further realized that a driver may desire to change the program settings.

Accordingly, the disclosure provides a wireless turbo boost controller that allows a user to remotely change the program settings for controlling a turbocharger. The program settings include but are not limited to a boost setpoint, a wastegate spring pressure, an overboost protection pressure, a sensitivity setting, a temporary boost signal, and an RPM boost adjustment. The boost setpoint is a percent of duty cycle of a solenoid control signal or a PSI value that is set by a user to control the maximum boost pressure that the turbocharger achieves. The wastegate spring pressure is the spring pressure of the wastegate installed in the vehicle. Typically, the wastegate spring pressure is set to three to five PSI below the actual spring pressure of the wastegate. The overboost protection pressure is a threshold pressure that if reached during operation, the wireless turbo boost controller opens the solenoid so that the wastegate is allowed to vent pressure and the vehicle is returned to a “stock” state until the turbo boost pressure returns to a safe operating condition. The sensitivity setting or gain is used to set the response time to how quickly or slowly a turbo boost control system responds to changes in the turbo manifold pressure. The temporary boost signal is used to cause an increase in the turbo boost pressure for a brief period of time, such as between one to ten seconds, when activated by a user. The RPM boost adjustment is a signal that causes a change in the turbo boost pressure. The RPM boost adjustment is based on the RPM of the engine and allows the user to make a change base thereon. The disclosure also provides a method and a computer program product to remotely operate a wireless turbo boost controller. Thus, the disclosure provides an apparatus and method that allows a user to modify the operation of a turbocharger via an easy to use interface.

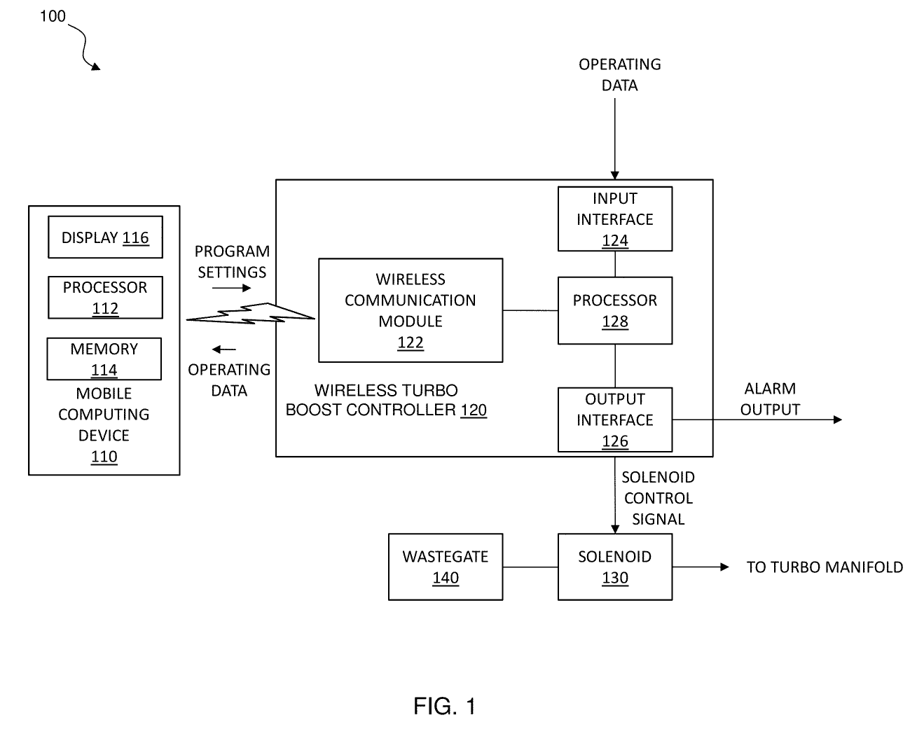

FIG. 1 illustrates a block diagram of an embodiment of a turbo boost control system 100 constructed according to the principles of the disclosure. The turbo boost control system 100 can be used in various vehicles to control the operation of a turbocharger. The turbo boost control system 100 includes a mobile computing device 110, a wireless turbo boost controller 120, a solenoid 130, and a wastegate 140.

The mobile computing device 110 as used herein is a device having a primary function that is not associated with the operation, maintenance, or testing of vehicles. Accordingly, the mobile computing device 110 does not have the primary function of operating or interfacing with a turbo boost controller. For example, the mobile computing device 110 can be a mobile telephone (including smart phones), a tablet, a computing pad, etc., that includes at least one processor, memory and display. One skilled in the art will also understand that the mobile computing devices disclosed herein have other components that are typically included in such devices including a power supply, communications interface, etc. In one embodiment disclosed herein, the mobile computing device 110 has a communications interface that is Bluetooth compliant. Bluetooth-compliant transceivers are wirelessly coupled via a Bluetooth communications environment as defined in the various versions of the Bluetooth wireless technology standard managed by the Bluetooth Special Interest Group.

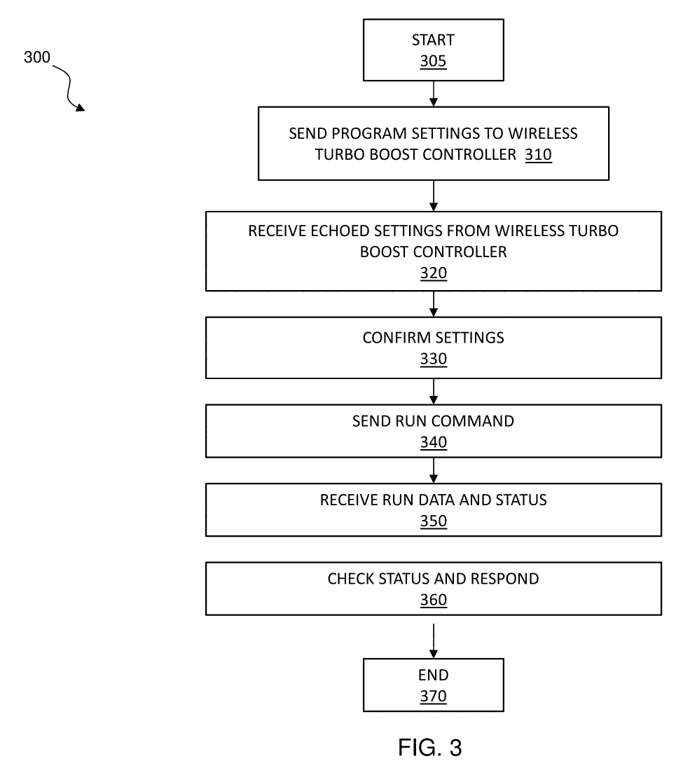

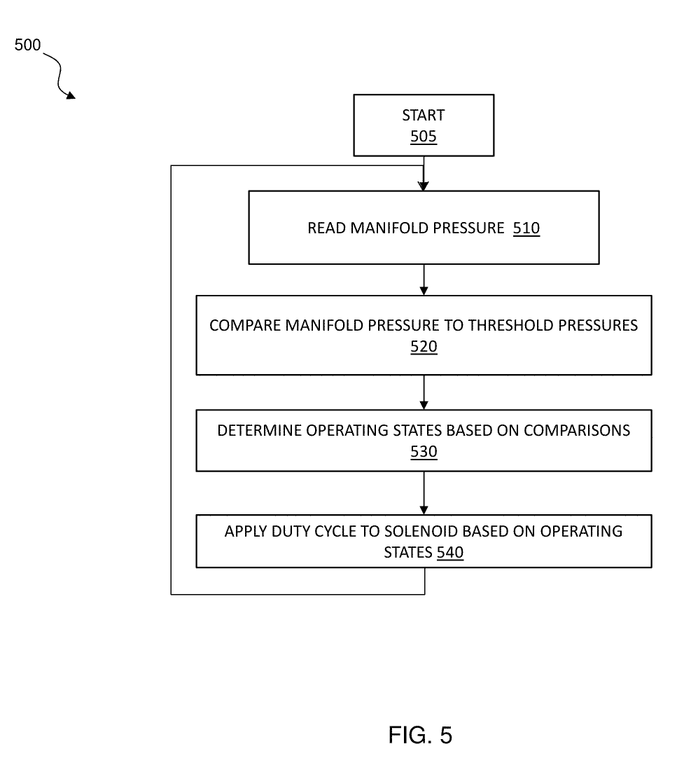

As noted above the mobile computing device 110 includes a processor 112, a memory 114, and a display 116. The processor 112 is configured to direct operation of the mobile computing device 110. The memory 112 is a non-transitory memory that includes code stored thereon that directs the processor 110 to perform a method to remotely direct operation of the wireless turbo boost controller 120 by, for example, transmitting program settings thereto. The method carried out by the processor 112 may be, for example, the method illustrated in FIG. 3 or FIG. 5.

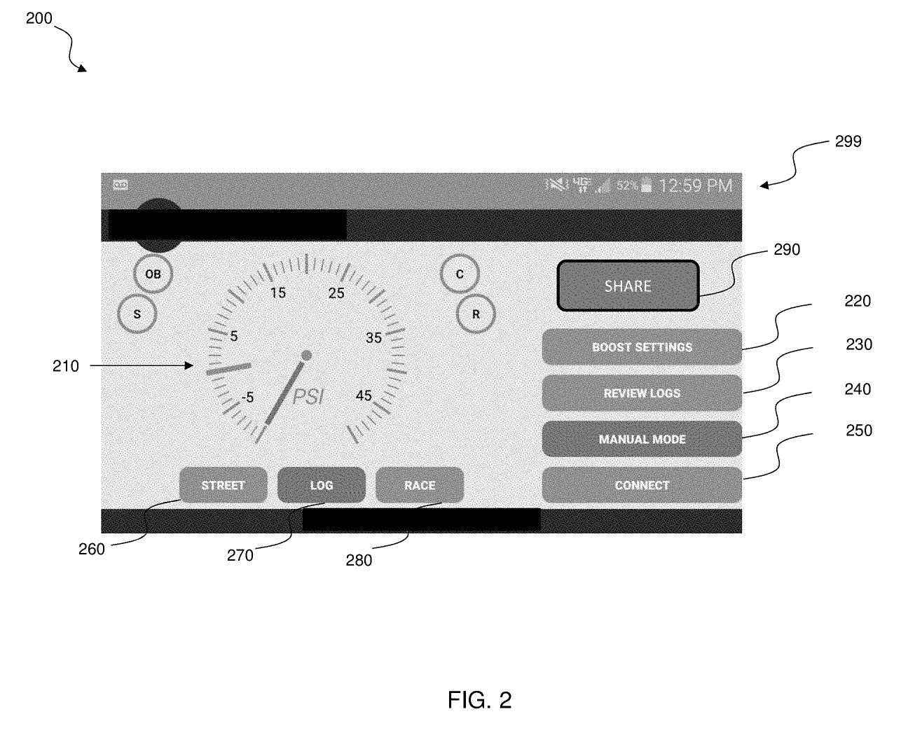

The display 116 is configured to provide a visual interface between a user and the computer program product stored on the memory 114. The display 116 also provides additional functions and features such as operational, diagnostic and status messages of the turbocharger via the computer program product, referred to herein as a turbo controller application. The disclosed functions and features provide an improved interface mechanism for informing users and receiving inputs to change operating parameters for the wireless turbo boost controller 120. An example of a display is illustrated in FIG. 2.

The wireless turbo boost controller 120 is configured to regulate a manifold pressure applied to the wastegate 140 by employing the solenoid 130 and at least one program setting wirelessly received. The wireless turbo boost controller 120 includes a wireless communication module 122, an input interface 124, an output interface 126, and a processor 128.

The wireless communication module 122 is configured to communicate over a wireless connection with the mobile computing device 110. In one embodiment, the wireless connection is a Bluetooth-compliant connection. The wireless communication module 122 is configured to receive program settings from the mobile computing device 110 and send vehicle operating data to the mobile computing device 110. The wireless communication module 122 may communicate additional information to and from the mobile computing device 110, such as confirmation of transmissions. The wireless communication module 122 may include the structure and functionality of a conventional wireless communication device. In one embodiment, the wireless communication module 122 is a RFDUINO RFD22301 Bluetooth module.

The input interface 124 is configured to receive operating data from the vehicle. The input interface 124 can be a conventional interface having multiple ports for receiving data. The multiple ports can be distributed in different locations of the wireless turbo boost controller 120. In one embodiment the input interface 124 receives the vehicle operating data from wired connections. The vehicle operating data includes a pressure signal indicative of a manifold pressure of an engine of the vehicle and a RPM signal indicative of an RPM of the engine of the vehicle. In some embodiments, the vehicle operating data also includes a battery status signal and a solenoid status signal. The battery status signal indicates the current charged voltage of the battery of the vehicle or if the battery voltage is good, low, or needs charging. The solenoid status signal indicates if the solenoid becomes disconnected or shorted. The operating data can be sent to the mobile computing device 110 via the wireless communication module 122. The mobile computing device 110 can employ the turbo controller application to alert or inform a user based on the operating data.

The output interface 126 is configured to send vehicle information to the vehicle from the wireless turbo boost controller 120. The vehicle information can then, for example, be visually provided on a display of the dashboard of the vehicle. The output interface 126 can be a conventional interface having multiple ports for transmitting data. The multiple ports can be distributed in different locations of the wireless turbo boost controller 120. In one embodiment the output interface 124 transmits data, such as the vehicle information, via wired connections. As illustrated in FIG. 1, the vehicle information includes a solenoid control signal and alarm outputs. The alarm outputs can be an indicator of an open connector or that an overboost condition has occurred.

The processor 128 is configured to control the solenoid 130 based on the pressure signal, the RPM signal, and a program setting received via the wireless communication module 122 from the mobile communication device 110. The processor 128 can be a microcontroller. The processor 128 can receive the pressure signal, the RPM signal, and the program setting as inputs and determine, for example, a duty cycle of the solenoid control signal to control operation of the solenoid 130. In one embodiment, the processor 128 can control the solenoid 130 by changing the duty cycle based on the manifold pressure such that when the manifold pressure is less than a wastegate spring pressure, the processor 128 sets the duty cycle to 100%, and when the manifold pressure is greater than the wastegate spring pressure but less than an overboost threshold pressure, the processor 128 sets the duty cycle to a setpoint duty cycle. The setpoint duty cycle and overboost threshold pressure are examples of program settings received from the mobile computing device 110. Additionally, the processor 128 can set the duty cycle to 100% when the manifold pressure is less than the wastegate spring pressure and is greater than one, and test the solenoid 130 when the manifold pressure is less than one. The processor 128 can also shut down the solenoid 130 when the manifold pressure is greater than the overboost threshold pressure.

The solenoid 130 or solenoid valve is an electromechanically operated valve. The solenoid 130 is attached between the wastegate 140 and the turbo manifold to regulate turbo boost pressure. As noted above, the solenoid 130 is controlled by varying the duty cycle of the solenoid control signal.

FIG. 2 illustrates an embodiment of a display 200 of a mobile computing device having a turbo control application as disclosed herein. The mobile computing device 200 can be a smart phone and include operating parameters 299 of the device. The display 200 provides a visual interface for communicating with a user and allowing the user to remotely control a wireless turbo boost controller of a vehicle. The display 200 can be a conventional touch screen of a mobile computing device that allows activation of menu buttons when touched. The display 200 includes a digital gauge 210 that monitors the turbo boost pressure of a turbocharger in real time over a wireless link and visually indicates that turbo boost pressure. The display 210 also includes menu buttons, boost settings 220, review logs 230, manual mode 240, and connect 250, that perform the following functions when activated.

The boost settings 220 allow a user to choose or enter program settings for the wireless turbo boost controller. The review logs 230 allow a user to access notes and historical data accumulated from previous operations. The manual mode 240 allows a user to adjust settings to the wireless turbo boost controller in real time. The connect 250 initiates the mobile computing device to wirelessly connect to the wireless turbo boost controller. The display 200 includes additional menu buttons, street 260, log 270, and race 280, that also perform or allow certain functions when activated. The street 260 and race 280 buttons select between two different settings profiles that can be defined and edited via the boost settings 220. The log 270 allows a user to enter information, notes, and data associated with operation of the vehicle.

The display also provides an additional menu button, share 290. The share 290 button allows a social media sharing feature, where a community can share vehicle and controller information, such as, the make/model of their vehicle, the settings they used in the controller, and the results from the settings. Other users can simply download these settings into their mobile computing device via conventional means and, with an application as disclosed herein, program the controllers of their vehicles.

FIG. 3 illustrates a flow diagram of an embodiment of a method 300 of remotely operating a wireless turbo boost controller carried out according to the principles of the disclosure. The method 300 may be carried out by a mobile computing device with a turbo control application as disclosed herein. The method 300 begins in a step 305.

In a step 310, program settings are sent to a wireless turbo boost controller. The settings can be sent over a Bluetooth connection. In some embodiments a single program setting, such as a set point duty cycle, may be sent.

In a step 320, echoed settings are received from the wireless turbo boost controller. The echoed settings are used to verify that the program settings that were sent are the one that were received.

The settings are confirmed in a step 330. The settings can be confirmed by comparing the sent program settings to the received echoed settings. In one embodiment, a confirmed bit of a data structure is set to one when the confirmation is complete. If the programs settings are not confirmed, steps 310 to 330 can be repeated until a successful confirmation is achieved.

In a step 340, a run command is sent to the wireless turbo boost controller. With the run command, the program settings and an updated status can be sent to the wireless turbo boost controller. The updated status can be indicated in a updated status byte of a data structure. A wireless communication module of the wireless turbo boost controller can receive the program settings and send the echoed settings for the wireless turbo boost controller. The wireless communication module can send the run commands and program settings to a processor of the wireless turbo boost controller for an accuracy check and determine if satisfactory. If satisfactory, a run bit can be set to one as an indication. The wireless communication module can then send the program settings and updated status to the processor and also to, for example, the mobile communication device. The processor can employ the program settings to operate the turbocharger.

In a step 350, the run data and status are received. The run data corresponds to operation of the turbocharger employing the program settings. The status can be provided by a status byte of a data structure.

In a step 360, the status is checked and a response based thereon is sent to the wireless turbo boost controller. The method 300 may check the status by determining if an error bit has been set in a received status byte from the wireless turbo boost controller. If an error, the method 300 can notify the user via, for example, a display of the mobile computing device. If a fatal error, the turbo boost control system can be shut down. If not a fatal error, the turbo boost control system can be allowed to recover and run again. Some fatal errors include solenoid failure, solenoid incorrectly connected, solenoid shorted, or hardware errors that cause the wireless turbo boost controller from working. The method 300 ends in a step 370.

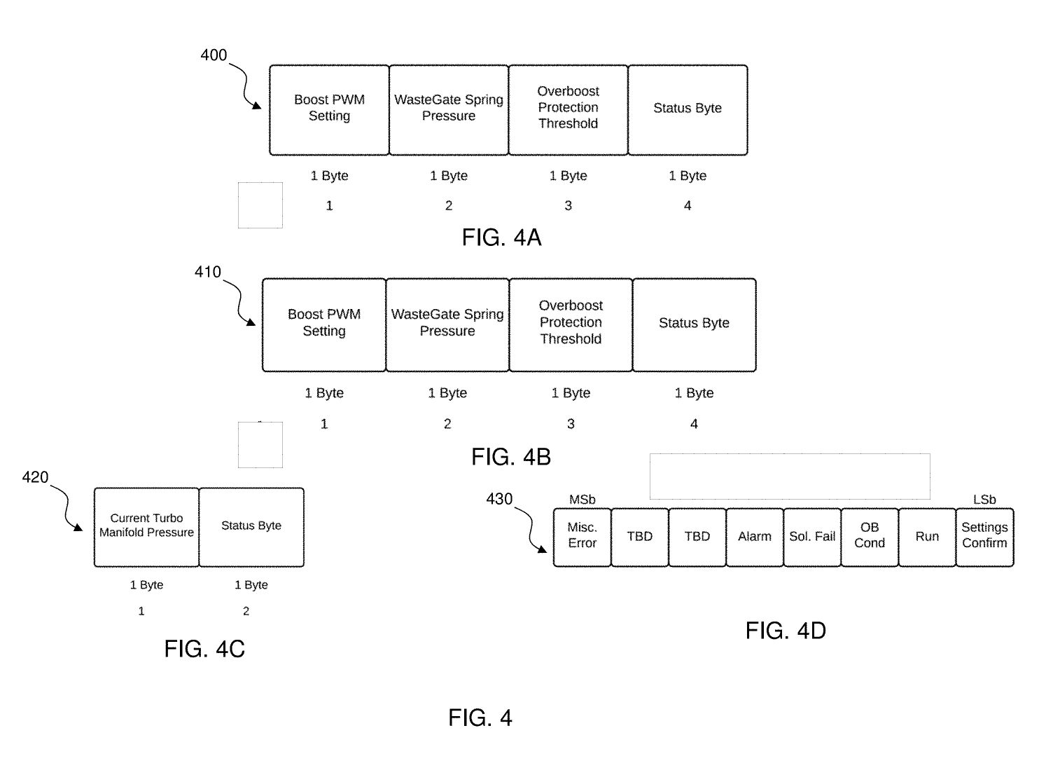

FIG. 4A, FIG. 4B, FIG. 4C, and FIG. 4D illustrate embodiments of data structures that are used to communicate data between a mobile computing device and a wireless communication module as disclosed herein. The various data structures may be employed by the method 300 to communicate information. FIG. 4A illustrates an output signal 400 that is transmitted from the mobile computing device to the wireless communication module having program settings. The output signal 400 includes four bytes of data transmitted in order from one to four as indicated in FIG. 4A. The first byte is the Boost PWM setting, the second byte is the wastegate spring pressure, the third byte is the overboost protection threshold and the fourth byte is the status byte.

FIG. 4B illustrates an echoed signal 410, having program settings, that is transmitted from the wireless communication module to the mobile computing device. The echoed signal 410 includes four bytes of data transmitted in order from one to four as indicated in FIG. 4B. The first byte is the Boost PWM setting, the second byte is the wastegate spring pressure, the third byte is the overboost protection threshold and the fourth byte is the status byte.

FIG. 4C illustrates vehicle operating data 420 that is transmitted from the wireless communication module to the mobile computing device. The vehicle operating data 420 includes two bytes of data transmitted in order from one to two as indicated in FIG. 4C. The first byte is the current turbo manifold pressure and the second byte is the status byte. In other embodiments, other types of vehicle data besides the current turbo manifold pressure can be transmitted using a similar format.

FIG. 4D illustrates a status byte 430 that is transmitted between the wireless communication module and the mobile computing device. The status byte 430 includes eight bits listed from most significant bit to the least significant bit. The first bit is as an error bit, the fourth bit is an alarm bit, the fifth bit is a solenoid fail bit, the sixth bit is an overboost condition bit, the seventh bit is a run command bit, and the eight bit is a settings confirmation bit. In the status byte 430, bits two and three are currently undesignated.

FIG. 5 illustrates a flow diagram of an embodiment of a method 500 of controlling a solenoid of a turbo boost control system carried out according to the principles of the disclosure. The method 500 may be carried out by a wireless turbo boost controller working with a mobile computing device having a turbo control application as disclosed herein. The wireless turbo boost controller can receive various program settings from the mobile computing device via a wireless communication module to use for controlling the solenoid. In the method 500, when a manifold pressure reaches a specified threshold range then the solenoid will operate at a user specified duty cycle. The duty cycle will stay static at that value based on the manifold pressure. An example of the program settings for the method 500 that are set via the turbo control application and wirelessly transmitted are boost PWM duty cycle, wastegate spring pressure, overboost protection threshold, and spooling PWM duty cycle. Thus, in addition to the program settings communicated via the output signal 400 and the echoed signal 410, the spooling PWM duty cycle would be communicated. A byte could be used for this program setting as with the other program settings noted in the output signal 400 and the echoed signal 410. The method 500 begins in a step 505.

In a step 510, a manifold pressure of a vehicle is read. The manifold pressure can be determined via a conventional method or device. The manifold pressure can be sent to the mobile computing device for display to a user in real time.

In a step 520, the manifold pressure is compared to threshold pressures. The threshold pressures may be based on the type of vehicle or turbocharger. In some embodiments, the threshold pressures can be set or changed by a user via the mobile computing device. The threshold pressures can establish a threshold range to determine what threshold range the measured manifold pressure is within. The ranges can vary depending on the application. For the method 500, a first range is when the threshold pressure is less than zero. A second range is when the threshold pressure is greater than zero but less than the wastegate spring pressure. A third range is when the manifold pressure is greater than the wastegate spring pressure but less than the overboost pressure threshold. A fourth range is when the manifold pressure is greater than the overboost pressure threshold.

In a step 530, an operating state is determined based on the comparison performed in step 520. Continuing with the example ranges discussed above, when in the first range, the controller state is a vacuum. In the second range, the controller state is spooling. When in the third range, the controller state is a control state. In the fourth range, the controller state is overboost.

In a step 540, a duty cycle is sent to the solenoid based on the controller states. The duty cycle can be sent to the solenoid via a solenoid control signal from the wireless turbo boost controller. For example, when in the vacuum state or overboost state, a 0% duty cycle is applied. In the spooling state, the spooling PWM duty cycle is applied. In the control state, the boost PWM duty cycle is applied.

The method 500 continues to step 510 where the manifold pressure is again read.

In an alternative embodiment to the method 500, instead of applying a static duty cycle, the controller continuously changes the duty cycle of the solenoid to try and reduce the error between a boost pressure setpoint and the current manifold pressure. Thus, instead of the user inputting a duty cycle, the user inputs a pressure setpoint and the controller tries to maintain it. The difference in this embodiment between the method 500 occurs in the control state. Instead of applying the boost PWM duty cycle, a boost error is calculated, a proportional-integral-derivative controller (a PID controller) is employed, and based thereon, a control duty cycle is applied to the solenoid. For this alternative, more program settings are used and exchanged via a wireless connection. An example of the program settings for this alternative that are set via the turbo control application and wirelessly transmitted are boost pressure setpoint, direct gain, cumulative gain, rate gain, and cumulative gain limit. These settings are used by the PID controller for providing the control duty cycle. Thus, these program settings can be communicated via a similar data structure such as the output signal 400 and the echoed signal 410. A byte each could be used for these program settings as with the other program settings noted in the output signal 400 and the echoed signal 410.

The above-described system, apparatus, and methods or at least a portion thereof may be embodied in or performed by various processors, such as digital data processors or computers, wherein the computers are programmed or store executable programs of sequences of software instructions to perform one or more of the steps of the methods. The software instructions of such programs may represent algorithms and be encoded in machine-executable form on non-transitory digital data storage media, e.g., magnetic or optical disks, random-access memory (RAM), magnetic hard disks, flash memories, and/or read-only memory (ROM), to enable various types of digital data processors or computers to perform one, multiple or all of the steps of one or more of the above-described methods or functions of the system or apparatus described herein.

Certain embodiments disclosed herein can further relate to computer storage products with a non-transitory computer-readable medium that have program code thereon for performing various computer-implemented operations that embody the apparatuses, the systems or carry out the steps of the methods set forth herein. Non-transitory medium used herein refers to all computer-readable media except for transitory, propagating signals. Examples of non-transitory computer-readable medium include, but are not limited to: magnetic media such as hard disks, floppy disks, and magnetic tape; optical media such as CD-ROM disks; magneto-optical media such as floptical disks; and hardware devices that are specially configured to store and execute program code, such as ROM and RAM devices. Examples of program code include both machine code, such as produced by a compiler, and files containing higher level code that may be executed by the computer using an interpreter.

Those skilled in the art to which this application relates will appreciate that other and further additions, deletions, substitutions and modifications may be made to the described embodiments.

What is claimed is:

1. A wireless turbo boost controller configured to control a wastegate solenoid of a turbo boost control system of a vehicle, the wireless turbo boost controller comprising:
a wireless communication module;
an input interface configured to receive a pressure signal indicative of a manifold pressure of an engine of the vehicle and a RPM signal indicative of an RPM of the engine of the vehicle; and
a processor configured to control the wastegate solenoid of the turbo system based on the pressure signal, the RPM signal, and at least one program setting received via the wireless communication module.

2. The wireless turbo boost controller of claim 1 wherein the processor is configured to control the wastegate solenoid by changing a duty cycle of a solenoid control signal based on the manifold pressure such that:
when the manifold pressure is less than a wastegate spring pressure of a wastegate of the turbo boost control system, the processor sets the duty cycle to 100%; and
when the manifold pressure is greater than the wastegate spring pressure but less than an overboost threshold pressure, the processor sets the duty cycle to a setpoint duty cycle received via the wireless communication module.

3. The wireless turbo boost controller of claim 2 wherein the processor is configured to set the duty cycle to 100% when the manifold pressure is less than the wastegate spring pressure and is greater than one, and tests the solenoid when the manifold pressure is less than one.

4. The wireless turbo boost controller of claim 3 wherein the processor is further configured to shut down the solenoid when the manifold pressure is greater than the overboost threshold pressure.

5. The wireless turbo boost controller of claim 2 wherein the wireless turbo boost controller receives the setpoint duty cycle while the vehicle is moving and the processor controls the wastegate solenoid with the setpoint duty cycle in real time while the vehicle is moving.

6. The wireless turbo boost controller of claim 2 wherein the wireless turbo boost controller receives the setpoint duty cycle via the wireless communication module from a mobile computing device during a user defined time period.

7. The wireless turbo boost controller of claim 6 wherein the wireless communication module is configured to send a solenoid status signal to the mobile communication device.

8. The wireless turbo boost controller of claim 6 wherein the wireless communication module is configured to send a vehicle battery status signal to the mobile communication device.

9. The wireless turbo boost controller of claim 6 wherein the wireless communication module is further configured to receive a sensitivity setting from the mobile computing device.

10. The wireless turbo boost controller of claim 6 wherein the wireless turbo boost controller is configured to send an overboost alarm to the mobile computing device via the wireless communication module when the manifold pressure is above an overboost threshold pressure.

11. The wireless turbo boost controller of claim 6 wherein the wireless turbo boost controller is configured to send the RPM signal to the mobile computing device via the wireless communication module.

12. The wireless turbo boost controller of claim 11 wherein the setpoint duty cycle can be adjusted by the user based on the RPM signal and employing the mobile computing device.

13. The wireless turbo boost controller of claim 1 wherein the wireless communication module is a BLUETOOTH® communication module.

14. A computer program product for operating a wireless turbo boost controller in a turbo system of a vehicle, wherein the computer program product includes code stored on a non-transitory computer-readable medium of a mobile computing device that directs a processor of the mobile computing device to perform a method to direct operation of a wireless turbo boost controller, the method comprising:
providing a setpoint duty cycle; and
sending the setpoint duty cycle to the wireless turbo boost controller via a wireless communication module, wherein the wireless turbo boost controller generates a solenoid control signal from a pressure signal indicative of a manifold pressure of an engine of the vehicle, a RPM signal indicative of an RPM of the engine of the vehicle, and the setpoint duty cycle.

15. The computer program product of claim 14 wherein the method further comprises receiving the RPM signal from the wireless communication module.

16. The computer program product of claim 14 wherein the providing includes selecting the set point duty cycle from multiple options of set point duty cycles.

17. The computer program product of claim 14 wherein the method further includes receiving an overboost alarm from the wireless turbo boost controller and providing an indication of the overboost alarm.

18. The computer program product of claim 14 further comprising receiving a selection of a sensitivity setting and sending the sensitivity selection to the wireless turbo booster controller.

19. The computer program product of claim 14 wherein the setpoint duty cycle is received during a user defined time duration.

20. A turbo boost control system for a vehicle, comprising:
a wastegate solenoid; and
a wireless turbo boost controller configured to control the wastegate solenoid, the wireless turbo boost controller including:
a wireless communication module;
an input interface configured to receive a pressure signal indicative of a manifold pressure of an engine of the vehicle and a RPM signal indicative of an RPM of the engine of the vehicle; and
a processor configured to control the wastegate solenoid based on the pressure signal, the RPM signal, and at least one program setting received via the wireless communication module.
